(19) United States
(12) Patent Application Publication
(10) Pub. No.: US 2009/0024539 A1
(43) Pub. Date: Jan. 22, 2009

(54) METHOD AND SYSTEM FOR ASSESSING CREDIT RISK IN A LOAN PORTFOLIO

(76) Inventor: Christopher L. Decker, Littleton, CO (US)

Correspondence Address: Christopher L. Decker, 9446 West Walker Place, Littleton, CO, 80123, US

(21) Appl. No.: 12/171,175

(22) Filed: Jul. 10, 2008

Related U.S. Application Data
(60) Provisional application No. 60/950,045, filed on Jul. 16, 2007.

(51) Int. Cl. G06Q 40/00

(52) U.S. Cl. 705/36 R

(57) ABSTRACT

A method and system for assessing credit risk in a loan portfolio of a lending institution is described. One embodiment receives a risk rating for each loan in the loan portfolio, the risk rating having been assigned based on a set of risk characteristics associated with the loan's concentration segment in accordance with a bifurcated model; receives a set of characteristics for each loan in the loan portfolio; receives capital numbers associated with the lending institution; performs a set of calculations for the loan portfolio to produce a credit-risk snapshot of the loan portfolio at a particular time, the set of calculations including at least one of expected loss, unexpected loss, economic capital, value at risk, and shareholder value added; and outputs the credit-risk snapshot of the loan portfolio to a user. Some embodiments also produce a trend analysis based on a plurality of credit-risk snapshots.

### PRIORITY

The present application claims priority from commonly owned and assigned U.S. Provisional Application No. 60/950,045, Attorney Docket No. STUR-001/00US 307790-2001, entitled “Credit Risk Model for Financial Lenders,” which is incorporated herein by reference in its entirety.

### FIELD OF THE INVENTION

The present invention relates generally to computerized financial analysis systems. More specifically, but not by way of limitation, the present invention relates to methods and systems for assessing credit risk in a loan portfolio of a lending institution.

### BACKGROUND OF THE INVENTION

Recent economic pressures have caused regulatory bodies to require banks of all sizes to quantify the risk in their loan portfolios and assess the impact of that risk on the bank's capital, the bank's loan and lease loss reserve, and the bank's earnings. Several large companies have attempted to address this issue through the development of a credit risk model. All of these companies have developed “standalone” software solutions that tend to be inflexible. In addition, the most inexpensive version of such a standalone software solution costs $130,000 to set up and another $130,000 per year in subscription fees. Given the high cost of these solutions, most (if not all) are considered cost prohibitive for smaller community banks.

Aside from their prohibitively high cost, these standalone software solutions have several shortcomings. Some of the shortcomings are particular to specific developers; other shortcomings are more global in nature. Some of these shortcomings include the following: massive manual data entry (some conventional systems require entry of the financial statements of each individual loan customer to produce risk ratings), utilization of sampling and Monte Carlo simulation, narrow focus (e.g., commercial real estate only), dependency on other software modules, and use of variables and assumptions, such as national default data, which may or may not be relevant/applicable to the loan portfolio of a particular lending institution. Also, these conventional solutions are not sufficiently flexible to allow a lending institution to use its existing loan risk rating systems and/or portfolio segmentation.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and system for assessing credit risk in a loan portfolio of a lending institution. One illustrative embodiment is a method, comprising receiving a risk rating for each loan in the loan portfolio, each loan in the loan portfolio having been classified in one of a plurality of distinct concentration segments in accordance with its type, the risk rating for each loan in the loan portfolio having been assigned based on a set of risk characteristics associated with loans in its concentration segment, the risk rating assigned to each loan in the loan portfolio being based on a bifurcated model that takes into account probability of default and loss given default; receiving a set of characteristics for each loan in the loan portfolio, the set of characteristics for each loan including information that can be used to assess the credit risk associated with that loan; receiving capital numbers associated with the lending institution; performing, based on the assigned risk ratings, the sets of characteristics, and the capital numbers, a set of calculations for the loan portfolio to produce a credit-risk snapshot of the loan portfolio at a particular time, the set of calculations including at least one of expected loss, unexpected loss, economic capital, value at risk, and shareholder value added; and outputting the credit-risk snapshot of the loan portfolio to a user.

Another illustrative embodiment is a system, comprising at least one processor and a memory connected with the at least one processor, the memory containing a plurality of program instructions configured to cause the at least one processor to (a) receive a risk rating for each loan in the loan portfolio, each loan in the loan portfolio having been classified in one of a plurality of distinct concentration segments in accordance with its type, the risk rating for each loan in the loan portfolio having been assigned based on a set of risk characteristics associated with loans in its concentration segment, the risk rating assigned to each loan in the loan portfolio being based on a bifurcated model that takes into account probability of default and loss given default; (b) receive a set of characteristics for each loan in the loan portfolio, the set of characteristics for each loan including information that can be used to assess the credit risk associated with that loan; (c) receive capital numbers associated with the lending institution; (d) perform, based on the assigned risk ratings, the sets of characteristics, and the capital numbers, a set of calculations for the loan portfolio to produce a credit-risk snapshot of the loan portfolio at a particular time, the set of calculations including at least one of expected loss, unexpected loss, economic capital, value at risk, and shareholder value added; and (e) output the credit-risk snapshot of the loan portfolio to a user.

The methods of the invention can also be implemented, in part, as a plurality of program instructions executable by a processor and residing on a computer-readable storage medium.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying drawings, wherein:

FIG. 1 is a functional block diagram of a computer equipped with a credit risk model in accordance with an illustrative embodiment of the invention;

FIG. 2 is a flowchart of a computerized method for assessing credit risk in a loan portfolio of a lending institution in accordance with an illustrative embodiment of the invention;

FIG. 3 is a flowchart of a computerized method for assessing credit risk in a loan portfolio of a lending institution in accordance with another illustrative embodiment of the invention; and

FIG. 4 is a high-level block diagram of a computerized method for assessing credit risk in a loan portfolio of a lending institution in accordance with yet another illustrative embodiment of the invention.

### DETAILED DESCRIPTION

Various illustrative embodiments of the invention address the above and other shortcomings of the prior through the calculation of quantities such as expected loss, unexpected loss, economic capital, value at risk, risk-adjusted return on capital, and shareholder value added. These embodiments also allows a bank to analyze additional indicators of risk such as credit exposure, credit concentrations, criticized loans, past due loans, exceptions to loan policy, loans extended, and duration. A user can view “snapshots,” including a variety of charts and graphs, of the loan portfolio at specific times, and, in some embodiments, can also view a trend analysis generated from an aggregation of the calculations associated with such snapshots. Such a trend analysis can also be graphically overlaid, in some embodiments, with national or local economic trend data.

Some of the specific issues that these illustrative embodiments of the invention address are the following: The calculation of required reserves for loans subject to Statement of Financial Accounting Standards No. 5 (FAS 5) accounting, setting concentration limits based on calculated risk (value at risk), and stress testing (Economic Capital—by officer, branch, region, portfolio segment, officer/segment, branch/segment, region/segment, or the portfolio as a whole). Further, some embodiments permit a lending institution to use its existing systems and software and permit the lending institution to tailor the analysis to meet its specific needs.

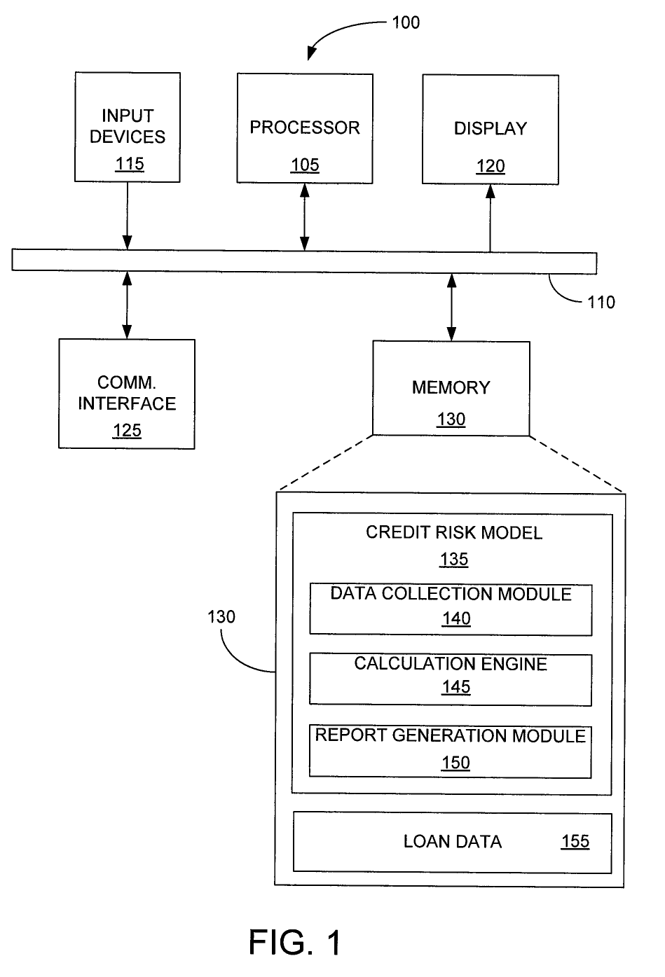

Referring now to the drawings, where like or similar elements are designated with identical reference numerals throughout the several views, and referring in particular to FIG. 1, it is a functional block diagram of a computer 100 equipped with a credit risk model 135 in accordance with an illustrative embodiment of the invention. Computer 100 may be any computing device capable of running credit risk model 135. For example, computer 100 may be, without limitation, a personal computer (PC), a server, a workstation, a laptop computer, or a notebook computer.

In FIG. 1, processor 105 communicates over system bus 110 with input devices 115, display 120, communication interface 125, and memory 130. Though FIG. 1 shows only a single processor, multiple processors or a multi-core processor may be present in some embodiments.

Input devices 115 include, for example, a keyboard, a mouse or other pointing device, or other devices that are used to input data or commands to computer 100 to control its operation.

In the illustrative embodiment shown in FIG. 1, communication interface 125 is a Network Interface Card (NIC) that implements a standard such as IEEE 802.3 (often referred to as “Ethernet”) or IEEE 802.11 (a set of wireless standards). In general, communication interface 125 permits computer 100 to communicate with other computers via one or more networks (e.g., a Local Area Network or the Internet). In communicating with other computers via a network, computer 100 may employ protocols such as the Internet protocol suite (TCP/IP), Hypertext Transfer Protocol (HTTP), Post Office Protocol (POP3), Internet Message Access Protocol (IMAP4), Simple Mail Transfer Protocol (SMTP), File Transfer Protocol (FTP), or other protocols.

Memory 130 may include, without limitation, random access memory (RAM), read-only memory (ROM), flash memory, magnetic storage (e.g., a hard disk drive), optical storage, or a combination of these, depending on the particular embodiment. For example, a storage device such as a hard disk drive may store a database of information about each of a plurality of loans making up the loan portfolio of a lending institution such as a bank or credit union.

In some embodiments, credit risk model 135 is implemented as a plurality of program instructions executable by processor 105. Prior to being loaded into RAM for execution, the plurality of program instructions making up credit risk model 135 may reside on a storage device containing a computer-readable storage medium such as, without limitation, a hard disk drive, a floppy diskette, an optical disc, or a flash memory. The plurality of program instructions may be divided into various instruction segments that cause processor 105 to carry out the methods of the invention. In such an embodiment, the combination of computer 100 and credit risk model 135 will sometimes be referred to herein as a “system.” In general, the functionality of credit risk model 135 may be implemented in software, firmware, hardware, or any combination or sub-combination thereof.

In some embodiments, credit risk model 135 is implemented in part as one or more worksheets of a spreadsheet application such as MICROSOFT EXCEL. In such an embodiment, each worksheet is populated with formulas in particular cells that instruct the spreadsheet application to perform particular calculations on loan data input to the worksheet in a predetermined format.

For the purposes of this Detailed Description, credit risk model 135 may be divided into various functional modules. In the embodiment shown in FIG. 1, credit risk model 135 includes data collection module 140, calculation engine 145, and report generation module 150. The division of credit risk model 135 into such functional modules is largely arbitrary, however, and the manner of dividing the functionality into functional modules and the names of those functional modules may differ in other embodiments. Credit risk model 135 makes use of loan data 155 in performing its assessment of the credit risk of a loan portfolio, as discussed further below.

Data collection module 140 receives the input data necessary to assess the credit risk of a loan portfolio of a lending institution. At a high level, such data may include a risk rating for each loan in the portfolio, a set of characteristics constituting essential loan information for each loan in the portfolio, and capital numbers (e.g., Tier-I and Tier-II capital) associated with the lending institution. Data collection module 140 is configured to receive and, to the extent necessary, format this input data in preparation for the calculations performed by calculations engine 145.

Calculation engine 145 performs a set of calculations for the loan portfolio based upon the input data collected and, if necessary, formatted by data collection module 140. At a high level, these calculations may include quantities such as, without limitation, expected loss, unexpected loss, economic capital, value at risk, and shareholder value added.

Report generation module 150 is configured to report the results of the calculations performed by calculation engine 145 to a user. In doing so, report generation module 150 employs text, charts, graphs, tables, or a combination thereof. Credit risk model 135 can be used to generate a credit risk report for the lending institution that can be viewed on display 120, printed, e-mailed, or otherwise communicated to the user.

The functionality of the above-mentioned functional modules will be described in greater detail below in connection with various illustrative embodiments of the invention.

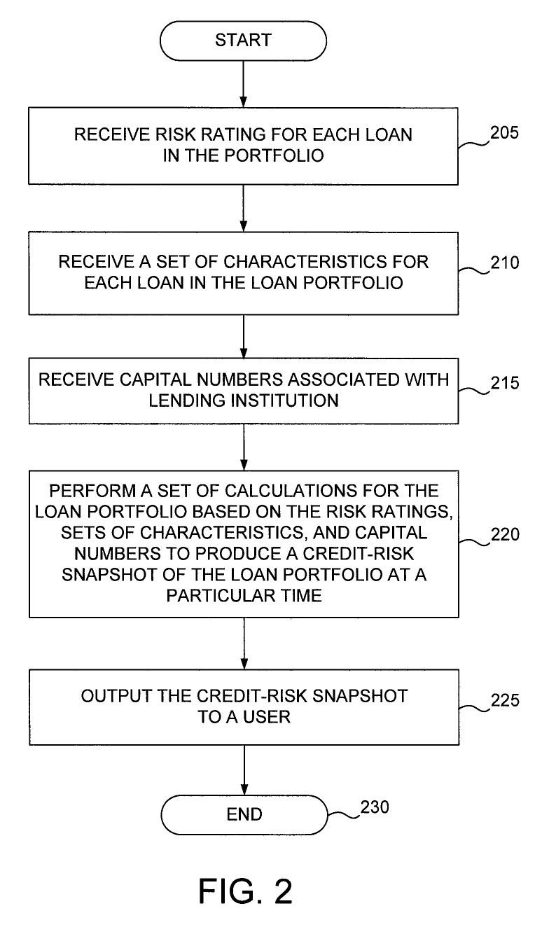

FIG. 2 is a flowchart of a computerized method for assessing credit risk in a loan portfolio of a lending institution in accordance with an illustrative embodiment of the invention. At 205, data collection module 140 receives a risk rating for each loan in the loan portfolio of the lending institution. The risk ratings may be stored, e.g., as part of loan data 155.

In this embodiment, at the time of origination, each loan is assigned a risk rating in accordance with a particular set of risk characteristics associated with the concentration segment to which it belongs. Each loan in the portfolio is classified as being in one of a set of concentration segments based on what type of loan it is. In one illustrative embodiment, the concentration segments include the following: Agricultural Non-Real-Estate (Ag. Non-R.E.), Agricultural Real Estate (Ag. R.E.), Commercial & Industrial (Comm'l & Ind.), Commercial Construction (Comm'l Const.), Commercial Real Estate—Investment (Comm'l R.E.—Investment), Commercial Real Estate—Owner Occupied (Comm'l R.E.—Owner Occupied), Consumer Non-Real-Estate (Cons. Non-R.E.), Consumer Real Estate Secured (Cons. R.E. Secured), Development Lots, Energy, Land Acquisition & Development (Land Acq. & Development), Residential Construction—Pre-Sold (Res. Const.—Pre-Sold), Residential Construction—Speculative/Model (Res. Const.—Spec/Model), and Residential Mortgage Loans (Res. Mort. Loans). In other embodiments, other concentration segments may be defined.

It should be noted that it is standard in the accounting industry and in regulatory bodies to categorize loans into only eight categories. For example, the standard classification system includes a category called “commercial real estate” that is so broad as to include one- to four-family homes being built by a residential home builder because it involves real estate and is a commercial operation. Research has shown, however, that one must employ at least nine pass-grade risk ratings to perform statistically viable calculations assessing the credit risk of a portfolio.

In the illustrative embodiment described above, 14 concentration segments are used to more finely distinguish among various types of loans, enabling the assignment of more accurate risk ratings. In some embodiments, the concentration segments may be reduced to 12 or some other smaller number by combining some concentration segments, or greater than 14 concentration segments may be defined, if needed.

One advantage of finer segmentation is that it permits meaningful comparisons of data from a specific segment with corresponding national or local economic data. Such national or local economic data may include, for example, leading, lagging, or coincidental indicators reflecting the condition of the national or local economy.

Each concentration segment has associated with it a set of risk characteristics associated with loans of that particular type or category. The risk characteristics may include, among other things, factors such as the method by which the loan is to be repaid. For example, for commercial loans, repayment from the cash flow of a business enterprise is considered a primary form of repayment, a call on guarantors is considered a secondary form of repayment, and liquidation of collateral is considered a tertiary form of repayment. In one embodiment, 12-13 such “risk metrics” may be associated with a particular concentration segment. Additional examples of risk metrics include, without limitation, loan to value, debt service coverage ratio (DSCR), guarantor's credit score, guarantor's liquidity, tangible net worth, and length of time in business.

Given the set of risk characteristics associated with the applicable concentration segment, the risk rating assigned to each loan in the loan portfolio is computed based on a bifurcated model that takes into account both probability of default and loss given default. This approach essentially combines a “credit rating” and a “collateral rating” to obtain the overall risk rating for a given loan. For example, when the severity or loss given default (LGD) is multiplied by the probability of default (PD), expected loss (EL) profiles can be obtained. Expected loss can be used to quantify and classify the combined effect of credit and collateral risk. It should be noted that such a risk matrix serves as the framework for an enterprise-wide risk model, which would include operational as well as credit risk. An illustrative risk-rating system is described in further detail on pp. 155-156 of U.S. Provisional Application No. 60/950,045.

Risk ratings such as those described above are used, in some embodiments, in lieu of allowance (contingency-planning) calculations required under FAS 5, with which banks are under regulatory pressure to comply.

One significant advantage of the above-described risk-rating approach is that it permits examination of every loan in the portfolio based on actual loan data rather than relying on, e.g., sampling and Monte Carlo simulation techniques.

Referring again to FIG. 2, at 210, data collection module 140 receives a set of characteristics for each loan in the loan portfolio. The set of characteristics for each loan includes what lending institutions might consider essential loan information that can be used to assess the credit risk associated with that particular loan. Examples of such characteristics include, without limitation, amount committed, amount outstanding, maturity date, loan grade, security (e.g., collateral), yield, and interest rate. In one particular embodiment, the set of characteristics associated with a given loan includes 26 components of information about the loan.

In one illustrative embodiment, the lending institution can use whatever report-writing software it currently uses (e.g., Crystal Reports or Prime Reports) to “mine,” from loan data 155, the information making up the set of characteristics for each loan.

At 215, data collection module 140 receives capital numbers associated with the lending institution. These figures are typically obtainable from the financials or accounting system of the lending institution. Such capital numbers typically include capital on hand—Tier-I and Tier-II capital.

At 220, calculation engine 145 performs a set of calculations for the loan portfolio based on the assigned risk ratings of the respective loans, the sets of characteristics of the respective loans, and the capital numbers. The collective results of these calculations will be referred to herein as a “credit-risk snapshot” of the loan portfolio at a particular time. At a high level, the calculations include one or more of the following: expected loss, unexpected loss, economic capital, value at risk, and shareholder value added.

In some embodiments, additional quantities may be calculated and reported. For example, concentration limits may be calculated. In one embodiment, concentration limits are computed based on value at risk as an upper limit using the formula

(Capital−Economic Capital)/(Loss Rate)=Loss Limit.

In this embodiment, a confidence interval (e.g., 99.95%) is applied to economic capital (value at risk) to set the maximum loss—the figure that losses for the loan portfolio will not exceed at the applicable level of confidence. In some embodiments, the confidence intervals are determined based on actual loan-grade distributions instead of a theoretical normal (Gaussian) distribution. Knowledge of the concentration limits permits a lender to determine how much more may be added to the books or how much needs to be taken off of the books to maintain a desired risk profile. Additional details regarding the computation of concentration limits can be found on pp. 154-155 of U.S. Provisional Application No. 60/950,045.

In one embodiment, calculation engine 145 uses the following formulas in calculating expected loss (EL), unexpected loss (UL), and economic capital (EC):

EL=PD×LGD×EAD

UL=SQRT([PD×(1−PD)]×LGD×EAD

EC=UL−EL,

where “PD” is probability of default, “LGD” is loss given default, “EAD” is exposure at default, and “SQRT” denotes a square-root operation.

For simplicity, the effects of correlation and maturity have been excluded in the above equations. In some embodiments, the correlation factor is added to PD in the calculation of UL. The formula used to calculate correlation (between regions and segments) is

r=SQRT[PD+(CF²×(1×PD))],

where “CF” is the relative concentration (region or segment). PD is adjusted by a maturity factor that is calculated by taking the one-year probability of default and estimating the current default based on straight-line proration over the remaining maturity of each credit facility up to 2.5 years. If less than one year, the one-year figure is used.

Additional information regarding the calculations performed by calculation engine 145, including stress testing, Allowance for Loan and Lease Losses (ALLL) Analysis, and pricing model considerations, can be found on pp. 149-158 of U.S. Provisional Application No. 60/950,045.

At 225, report generation module 150 outputs the credit-risk snapshot to a user. The results of a credit-risk assessment of the loan portfolio can be communicated to the user in any of a variety of ways, including, without limitation, e-mail, a site on the World Wide Web (“Web”), a secure File-Transfer-Protocol (FTP) server, a printed document, display 120, or a combination or sub-combination thereof. Examples of the kinds of information, including charts, graphs, and tables, output by an illustrative embodiment of credit risk model 135 are included on pp. 133-148 of U.S. Provisional Application No. 60/950,045. The categories of output include, in one illustrative embodiment, the following: Credit Exposure, Concentration Analysis, Criticized Loans, ALLL Analysis, Value at Risk (VaR) Analysis, Stress Testing, Risk-Adjusted Return on Capital (RAROC) Analysis, Shareholder Value Added Analysis, Exceptions to Loan Policy, Modified Duration Analysis, Times Extended, and Macroeconomic Trends.

In one embodiment, report generation module 150 is configured to aggregate the results associated with a given credit-risk snapshot by one or more of portfolio, geographic region, concentration segment, and branch. This permits an officer of a lending institution to, for example, assess the credit risk of the portion of the institution's loan portfolio associated with a particular geographic region (e.g., the Western U.S.). The aggregation of the calculations produced by calculation engine 145 will be discussed further below in the context of trend analyses.

At 230, the process terminates.

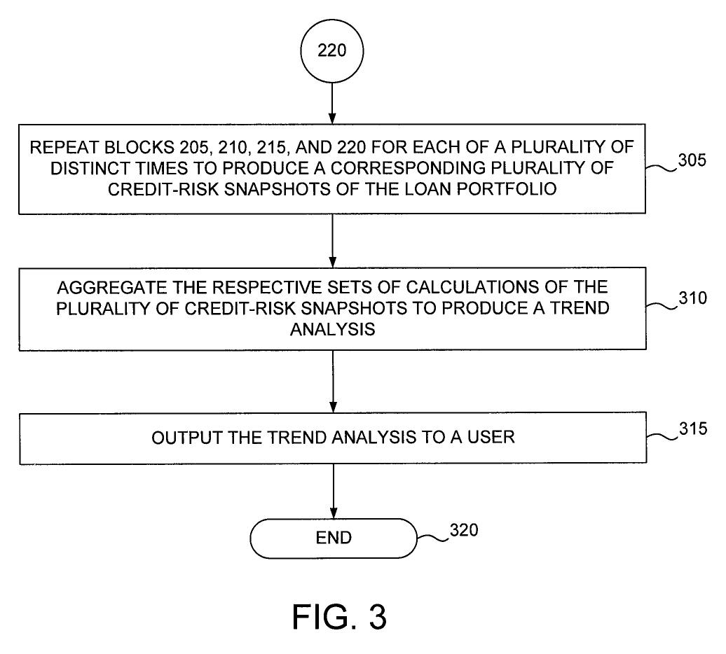

FIG. 3 is a flowchart of a computerized method for assessing credit risk in a loan portfolio of a lending institution in accordance with another illustrative embodiment of the invention. In the embodiment shown in FIG. 3, the method proceeds as in FIG. 2 through Block 220 (production of a credit-risk snapshot of the loan portfolio at a particular time). At 305, credit risk model 135 repeats Blocks 205, 210, 215, and 220 in FIG. 2 for each of a plurality of distinct times to produce a corresponding plurality of credit-risk snapshots of the loan portfolio.

At 310, credit risk model 135 aggregates the respective sets of calculations of the plurality of credit-risk snapshots of the loan portfolio to produce a trend analysis. Such a trend analysis may include, for example, plots of trend lines as a function of time. As described above in connection with individual credit-risk snapshots, the results aggregated across the plurality of credit-risk snapshots can also be aggregated according to one or more of portfolio, geographic region, concentration segment, and branch.

At 315, the trend analysis produced at 310 is output to a user. As with the outputting of individual credit-risk snapshots, the results of a trend analysis can be communicated to the user in any of a variety of ways, including, without limitation, e-mail, a Web site, a secure File-Transfer-Protocol (FTP) server, a printed document, display 120, or a combination or sub-combination thereof. One example of a trend analysis is shown under the category “Credit Exposure” on p. 133 of U.S. Provisional Application No. 60/950,045. At 320, the process terminates.

In one embodiment, the time between credit-risk snapshots making up a trend analysis is one month. In other embodiments, the time interval can be any value of interest to the lending institution. That is, a loan officer can use credit risk model 135 at arbitrary successive times to produce a group of credit-risk snapshots for a loan portfolio, and the resulting snapshots can be aggregated by credit risk model 135 to produce a trend analysis.

The trend analysis produced at 310 may, in some embodiments, incorporate national or local economic data (e.g., leading, lagging, or coincidental economic indicators). Examples of such data are shown on pp. 144-148 of U.S. Provisional Application No. 60/950,045 (see the graphs of “Macroeconomic Trends”). In some embodiments, report generation module 150 is configured to overlay national or local economic trend data with trend data corresponding to the loan portfolio of the lending institution so that the trends may be compared easily and conveniently.

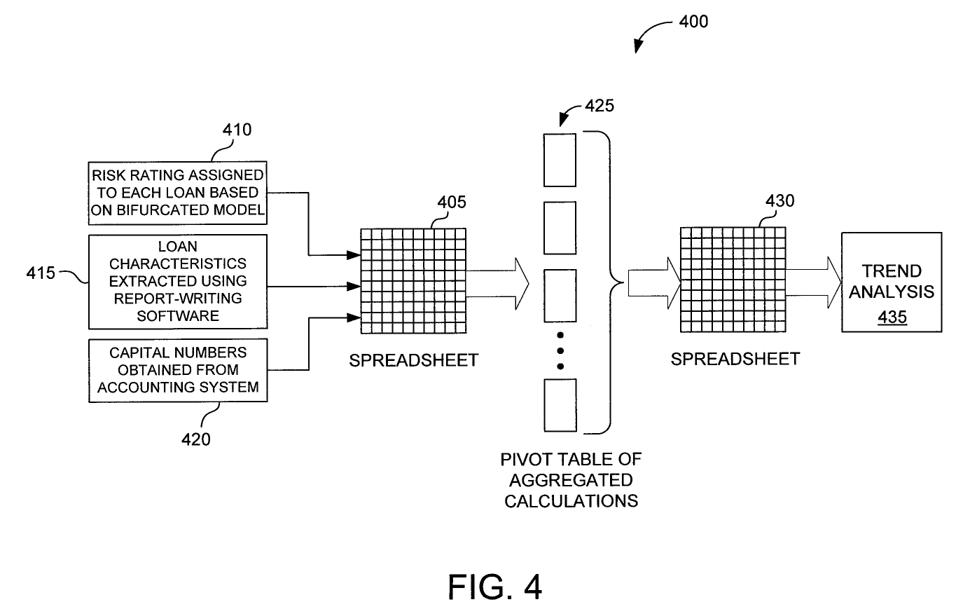

FIG. 4 is a high-level block diagram of a computerized method for assessing credit risk in a loan portfolio of a lending institution in accordance with yet another illustrative embodiment of the invention.

The embodiment shown in FIG. 4 is implemented using a spreadsheet application such as MICROSOFT EXCEL. Such an implementation overcomes the shortcomings of prior solutions by improving compatibility with existing bank software and by allowing more flexibility in use. Further, this implementation does not require additional software or programs and leverages a bank's existing report-writing software (e.g., Incognos Prime or other report writing software) and MICROSOFT OFFICE. By creating the model in a spreadsheet application, users can tailor the results specific to their operations and portfolio composition.

The process begins with each loan in the loan portfolio being assigned a risk rating 410, as discussed above. The embodiment shown in FIG. 4 can incorporate a bank's existing risk-rating system, or it can employ a risk-rating system based on a bifurcated model such as that described above in connection with FIG. 2.

Next, a report-writing software application is used to extract or “mine” the information making up the set of characteristics 415 associated with each loan in the loan portfolio (see also Block 210 in FIG. 2). In this particular embodiment, 26 components of information are collected. That number could be different in other embodiments. The particular report-writing software used is not important, but the report-writing software is used to organize and format the sets of characteristics associated with the loans in a prescribed manner for input to the spreadsheet application (e.g., EXCEL). For convenience in some embodiments, the report-writing software is configured to format the data in EXCEL format for easy copying and pasting into an EXCEL worksheet. The credit risk model could be adjusted to accommodate a different organization or input data format, but it is generally easier to format the input data to fit the model than it is to retrofit the model to fit the input data. An implementation based on MICROSOFT EXCEL permits (at this writing) a user to analyze 65,535 loans, assuming each loan were to occupy one horizontal line (or row) within MICROSOFT EXCEL.

The capital numbers 420 (e.g., Tier-I and Tier-II capital) are also input to the credit risk model, as explained above. The user thus inputs the risk ratings 410, sets of characteristics 415, and capital numbers 420 to spreadsheet 405 (e.g., a MICROSOFT EXCEL worksheet).

The credit risk model then performs, in this illustrative embodiment, approximately 225 calculations for each loan. These calculations were described at a high level above in connection with FIG. 2 and are described in greater detail in U.S. Provisional Application No. 60/950,045. Using pivot tables and graphs, these calculations are consolidated or “rolled up” (aggregated) at various levels such as portfolio, region, segment, or branch and provide the user with a “snapshot,” at a particular time, of the credit risk associated with the loan portfolio, as described above. The output can be tailored for specific users such as regional presidents, senior lenders, boards of directors, etc. In this embodiment, one of the pivot tables (425 in FIG. 4) within the credit risk model provides a “roll-up” (aggregation) of various calculations (e.g., by portfolio, region, segment, branch, etc.). Pivot table 425 can then be “copied and pasted” or otherwise input to a secondary spreadsheet 430 (e.g., another MICROSOFT EXCEL worksheet), which facilitates a trend analysis 435. In some embodiments, pivot table 425 arranges the aggregated calculations into the same format as the data (410, 415, and 420) originally input to spreadsheet 405.

A detailed printout of one illustrative spreadsheet implementation of a credit risk model is provided on pp. 62-110 of U.S. Provisional Application No. 60/950,045.

In conclusion, the present invention provides, among other things, a method and system for assessing credit risk in a loan portfolio of a lending institution. Those skilled in the art can readily recognize that numerous variations and substitutions may be made in the invention, its use, and its configuration to achieve substantially the same results as achieved by the embodiments described herein. Accordingly, there is no intention to limit the invention to the disclosed illustrative forms. Many variations, modifications, and alternative constructions fall within the scope and spirit of the disclosed invention as expressed in the claims.

What is claimed is:

1. A computerized method for assessing credit risk in a loan portfolio of a lending institution, the computerized method comprising:
receiving a risk rating for each loan in the loan portfolio, each loan in the loan portfolio having been classified in one of a plurality of distinct concentration segments in accordance with its type, the risk rating for each loan in the loan portfolio having been assigned based on a set of risk characteristics associated with loans in its concentration segment, the risk rating assigned to each loan in the loan portfolio being based on a bifurcated model that takes into account probability of default and loss given default;
receiving a set of characteristics for each loan in the loan portfolio, the set of characteristics for each loan including information that can be used to assess the credit risk associated with that loan;
receiving capital numbers associated with the lending institution;
performing, based on the assigned risk ratings, the sets of characteristics, and the capital numbers, a set of calculations for the loan portfolio to produce a credit-risk snapshot of the loan portfolio at a particular time, the set of calculations including at least one of expected loss, unexpected loss, economic capital, value at risk, and shareholder value added; and
outputting the credit-risk snapshot of the loan portfolio to a user.

2. The computerized method of claim 1, further comprising:
repeating the computerized method for each of a plurality of distinct times to produce a corresponding plurality of credit-risk snapshots of the loan portfolio;
aggregating the respective sets of calculations of the plurality of credit-risk snapshots of the loan portfolio to produce a trend analysis; and
outputting the trend analysis to a user.

3. The computerized method of claim 2, wherein the respective sets of calculations of the plurality of credit-risk snapshots of the loan portfolio are aggregated according to at least one of portfolio, geographic region, concentration segment, and branch.

4. The computerized method of claim 2, wherein the trend analysis incorporates at least one of national and local economic data, the at least one of national and local economic data including at least one of leading, lagging, and coincidental economic indicators.

5. The computerized method of claim 4, wherein the trend analysis graphically overlays trends of the loan portfolio with trends of at least one of a national and a local economy.

6. The computerized method of claim 2, wherein the plurality of distinct times are one month apart.

7. The computerized method of claim 1, wherein the plurality of concentration segments include at least nine concentration segments.

8. The computerized method of claim 1, wherein the risk rating assigned to each loan in the loan portfolio is determined at a time of origination of that loan.

9. The computerized method of claim 1, wherein the set of characteristics for each loan in the loan portfolio is received via a report-writing software program of the lending institution.

10. The computerized method of claim 1, wherein the set of characteristics for each loan in the loan portfolio includes at least one of amount committed, amount outstanding, maturity date, loan grade, information about collateral securing the loan, yield, and interest rate.

11. The computerized method of claim 1, wherein the capital numbers include at least one of Tier-I and Tier-II capital.

12. The computerized method of claim 1, wherein the set of calculations includes concentration limits and wherein each concentration limit is computed by applying a confidence interval to a value at risk to establish a maximum loss, at a selected level of confidence, for the loan portfolio.

13. The computerized method of claim 1, further comprising:
aggregating the set of calculations according to at least one of portfolio, geographic region, concentration segment, and branch.

14. The computerized method of claim 1, wherein the set of calculations is performed using a spreadsheet application.

15. A computer-readable storage medium containing a plurality of program instructions executable by a processor for assessing credit risk in a loan portfolio of a lending institution, the plurality of program instructions comprising:
a first instruction segment configured to receive a risk rating for each loan in the loan portfolio, each loan in the loan portfolio having been classified in one of a plurality of distinct concentration segments in accordance with its type, the risk rating for each loan in the loan portfolio having been assigned based on a set of risk characteristics associated with loans in its concentration segment, the risk rating assigned to each loan in the loan portfolio being based on a bifurcated model that takes into account probability of default and loss given default;
a second instruction segment configured to receive a set of characteristics for each loan in the loan portfolio, the set of characteristics for each loan including information that can be used to assess the credit risk associated with that loan;
a third instruction segment configured to receive capital numbers associated with the lending institution;
a fourth instruction segment configured to perform, based on the assigned risk ratings, the sets of characteristics, and the capital numbers, a set of calculations for the loan portfolio to produce a credit-risk snapshot of the loan portfolio at a particular time, the set of calculations including at least one of expected loss, unexpected loss, economic capital, value at risk, and shareholder value added; and
a fifth instruction segment configured to output the credit-risk snapshot of the loan portfolio to a user.

16. The computer-readable storage medium of claim 15, further comprising:
a sixth instruction segment configured to cause the first, second, third, fourth, and fifth instruction segments to repeat that for which they are configured for each of a plurality of distinct times to produce a corresponding plurality of credit-risk snapshots of the loan portfolio;
a seventh instruction segment configured to aggregate the respective sets of calculations of the plurality of credit-risk snapshots of the loan portfolio to produce a trend analysis; and
an eighth instruction segment configured to output the trend analysis to a user.

17. The computer-readable storage medium of claim 16, wherein the seventh instruction segment is configured, in producing the trend analysis, to aggregate the respective sets of calculations of the plurality of credit-risk snapshots of the loan portfolio according to at least one of portfolio, geographic region, concentration segment, and branch.

18. The computer-readable storage medium of claim 15, wherein the plurality of concentration segments include at least nine concentration segments.

19. The computer-readable storage medium of claim 15, wherein the set of calculations includes concentration limits and wherein the fourth instruction segment is configured to compute each concentration limit by applying a confidence interval to a value at risk to establish a maximum loss, at a selected level of confidence, for the loan portfolio.

20. A system for assessing credit risk in a loan portfolio of a lending institution, the system comprising:
at least one processor; and
a memory connected with the at least one processor, the memory containing a plurality of program instructions configured to cause the at least one processor to:
(a) receive a risk rating for each loan in the loan portfolio, each loan in the loan portfolio having been classified in one of a plurality of distinct concentration segments in accordance with its type, the risk rating for each loan in the loan portfolio having been assigned based on a set of risk characteristics associated with loans in its concentration segment, the risk rating assigned to each loan in the loan portfolio being based on a bifurcated model that takes into account probability of default and loss given default;
(b) receive a set of characteristics for each loan in the loan portfolio, the set of characteristics for each loan including information that can be used to assess the credit risk associated with that loan;
(c) receive capital numbers associated with the lending institution;
(d) perform, based on the assigned risk ratings, the sets of characteristics, and the capital numbers, a set of calculations for the loan portfolio to produce a credit-risk snapshot of the loan portfolio at a particular time, the set of calculations including at least one of expected loss, unexpected loss, economic capital, value at risk, and shareholder value added; and
(e) output the credit-risk snapshot of the loan portfolio to a user.

21. The system of claim 20, wherein the plurality of program instructions are further configured to cause the at least one processor to:
repeat (a)-(e) for each of a plurality of distinct times to produce a corresponding plurality of credit-risk snapshots of the loan portfolio;
aggregate the respective sets of calculations of the plurality of credit-risk snapshots of the loan portfolio to produce a trend analysis; and
output the trend analysis to a user.

22. The system of claim 21, wherein the plurality of program instructions are configured to cause the at least one processor to aggregate the respective sets of calculations of the plurality of credit-risk snapshots of the loan portfolio according to at least one of portfolio, geographic region, concentration segment, and branch.

23. The system of claim 20, wherein the plurality of concentration segments include at least nine concentration segments.

24. The system of claim 20, wherein the set of calculations includes concentration limits and wherein the plurality of program instructions are configured to cause the at least one processor to compute each concentration limit by applying a confidence interval to a value at risk to establish a maximum loss, at a selected level of confidence, for the loan portfolio.
